(19) United States
(12) Patent Application Publication
(10) Pub. No.: US 2006/0082375 A1
(43) Pub. Date: Apr. 20, 2006

(54) Apparatus and method for identification of a failing battery

(76) Inventor: Keven D. Coates, Cypress, TX (US)

Correspondence Address: TEXAS INSTRUMENTS INCORPORATED, P O BOX 655474, M/S 3999, DALLAS, TX, 75265, US

(21) Appl. No.: 10/968,415

(22) Filed: Oct. 19, 2004

(51) Int. Cl. G01N 27/416

(52) U.S. Cl. 324/430

(57) ABSTRACT

In order to determine when a battery is failing, the internal resistance is measured periodically. Because as a battery ages, the internal resistance increases, a table is maintained of periodic measurements of the battery internal resistance. Based on previous experience, an indicia can be identified from the table that permits the identification of the imminent failure of the battery.

### BACKGROUND OF THE INVENTION

1. Field of the Invention

This invention relates generally to electrical and electronic systems powered by a battery, and more particularly to the detection of the failing battery prior to actual failure.

2. Background of the Invention

Batteries have, since the early 20^{th} Century, played an important role in life of the average person. Early uses included assisting in the starting of motor vehicles, powering flash lights, and the powering portable devices such as, radios and music players. Recently, the increasing use of portable electronic devices such as computers and calculators, communication devices, memo units, etc. has resulted in a reexamination of the batteries that power these devices. For example, the portable communication devices typically include a display alerting the user when the device should be recharged.

A problem that is typically not resolved is the finite lifetime of the battery. The lifetime can be determined by the amount of usage, the type of usage, environmental factors such as ambient temperature, etc. Some indication that the battery is failing is the shortening time required between battery recharges. In internal combustion engines, the starting battery is being constantly charged during normal operation. However, prior to the implementation of the electronic ignition, difficulty in starting the engine frequently signaled that the battery was failing. Still, no consistent mechanism was found for warning a user of failing battery.

A need has therefore been felt for apparatus and an associated method having the feature of providing improved battery operation. It is a further feature of the apparatus and associated method to identify a failing battery. It is still a further feature of the apparatus and associated method to measure the internal resistance of a battery. It is yet another feature of the apparatus and associated method to measure the internal resistance of battery periodically and to store these values. It is yet a further feature of the apparatus and associated method to develop a table of internal resistance values over time. It is yet another feature of the apparatus and associated to identify from a time-dependent table of internal resistance values indicia of a failing battery.

### SUMMARY OF THE INVENTION

The aforementioned and other features are accomplished, according to the present invention, by providing apparatus for measuring the internal resistance of a battery over time. The values of the internal resistance are stored in a storage unit associated with a processing unit. The processing unit, in addition to controlling and storing the values of the internal resistance of the battery, reviews the table to determine if a predetermined characteristic has been identified. Examples of a suitable characteristic are the value of the internal resistance or the slope of the change in the internal resistance with time.

Other features and advantages of present invention will be more clearly understood upon reading of the following description and the accompanying drawings and the claims.

### BRIEF DESCRIPTION OF THE DRAWINGS

FIG. 1 is a schematic block diagram of the circuit for determining the internal resistance as a function of time.

FIG. 2 illustrates two parameters that can be used to determine when a battery is failing.

FIG. 3 is a block diagram of a second system for determining when a battery is entering a failing mode of operation.

### DESCRIPTION OF THE PREFERRED EMBODIMENT

### 1. Detailed Description of the Figures

Referring now to FIG. 1, a schematic block diagram of the technique for determining when a battery is failing is illustrated. A battery 10 can be represented by an equivalent circuit that includes a voltage source 10A and an (internal battery) resistance 10B coupled in series. In order to measure the internal resistance 10B of the battery, the voltage source 10A is measured by an open-circuit measurement of the voltage, i.e., the voltage across the terminals of the battery 10 under no-load conditions. This measurement is accomplished when the processing unit 15 activates the (normally-closed) switch 11 disconnecting the load 19 from the battery. At the same time, the processing unit 15 acquires the value of the voltage meter 14. Then, the processing unit 15 momentarily activates (normally-open) switch 12, thereby causing a current to flow through known resistance 13 between the terminals of battery 10. During the activation of switch 12, the voltage meter will provide a value of voltage across the known resistance 13. Dividing the voltage across the known resistance 13 by the value of the known resistance 13 yields the current through the known resistance 13. Next subtracting the voltage value across the known resistance 13 from the no-load voltage value and dividing the resulting difference voltage value by the current value through the known resistance provides the internal resistance. The internal resistance value of the battery can be stored in storage unit 16 and/or can be compared with an internal resistance value stored in the storage unit.

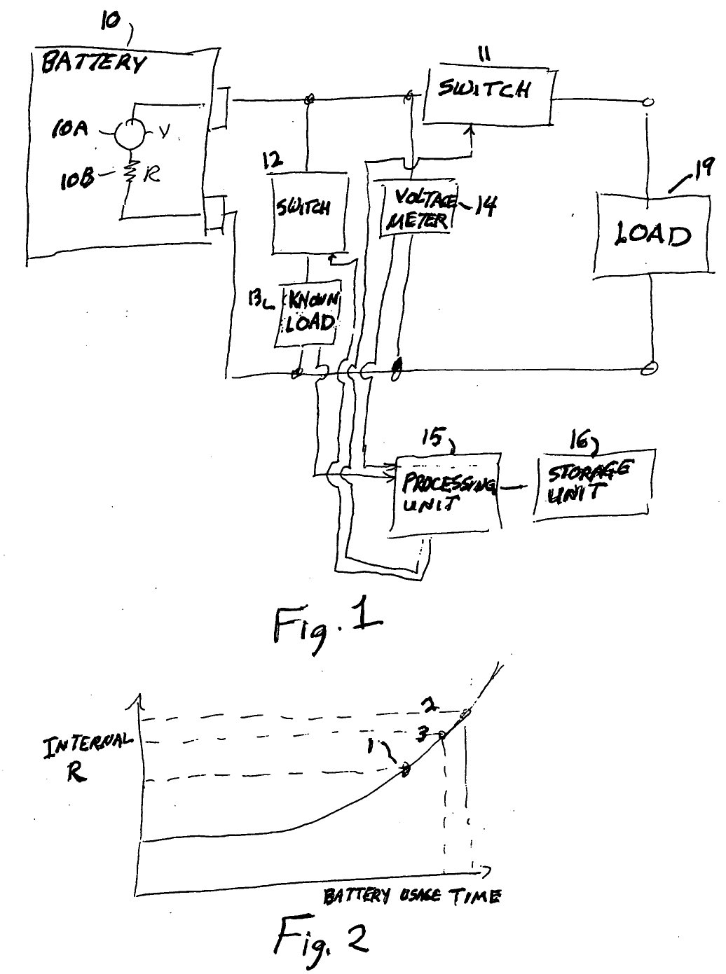

Referring to FIG. 2, two techniques for using the information obtained from the test configuration shown in FIG. 1 is illustrated. In the first technique, an predetermined value of internal battery resistance is stored in the storage unit 16. The predetermined value has been determined to be indicative of a failing battery. As each internal resistance value is measured, this new value is compared to the stored value. When the measured value is greater than or equal to the stored value, e.g. point 1, the battery is considered to be failing and the processing unit 15 alerts the user to replace the battery. In the second technique, the battery is considered to be failing when a predetermined slope of the curve of the internal resistance as a function of battery usage time has a slope that is greater than a predetermined stored slope value. The processing unit therefore makes a determination of the internal resistance as function of time. The internal resistance value is then stored as a function of battery usage time. When a new value of resistance and battery usage time is determined, these new values are used with the most recently stored resistance and time measurement to compute slope of the internal resistance curve, i.e., the slope between points 2 and 3 in FIG. 2. This computed slope is then compared to the stored (predetermined) value of the slope. Then the newly derived slope is greater than or equal to the stored slope value, the processing unit signals the user to change the battery.

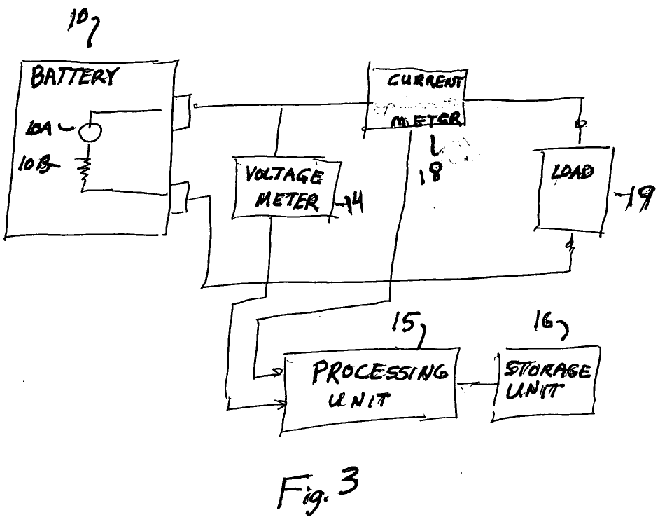

Referring to FIG. 3, a second technique for determining when a battery is failing is illustrated. In this technique, during the application of power to the load 19, the current to the load 19 is sampled by the current meter 13 and the voltage of the battery is sampled by the voltage meter 14. The sampled values of the current and voltage are applied to the processing unit. The processing unit 15 generates a sampled internal battery resistance value. The sampled resistance value is stored in the storage unit 16. Periodically, the processing unit 15 can determine an average resistance. The need for averaging is the result of the change in the power requirements of the load. Using an average resistance values, a determination can be made as to whether the resistance value or the resistance value slope is equal to or exceeds a predetermined value as illustrated in FIG. 2.

### 2. Operation of the Preferred Embodiment

The present invention provides a technique for identifying a failing resistor prior to the actual failure. The method for this determination relies on the observation that as a battery ages, the internal resistance increases. By identifying a value either for the internal resistance or the slope of the internal resistance and measuring the internal resistance, a determination can be made when the battery should be replaced. The use of the processing unit, which can in fact be part of the load, permits the computations, switch control, and storage and retrieval of data to be performed conveniently. Similarly, by controlling the switches and/or the acquisition of information, the measured value of internal resistance can be determined at an appropriate portion of the operating cycle. (As will be clear to those skilled in the art, the data must either be presented to the processing unit in a digital format or converted to a digital format for computation and storage.)

As will be seen, the processing unit is an important portion of the system for determining the internal resistance of a battery. Such a processing unit is obviously available in the portable electronic equipment. Moreover, most motor vehicles now contain a processing unit for monitoring and controlling portions of the motor vehicle. For example, anti-lock brakes require the use of a processing unit. Therefore, the computation and storage features needed to implement the present invention are typically already present.

While the invention has been described with respect to the embodiments set forth above, the invention is not necessarily limited to these embodiments. Accordingly, other embodiments, variations, and improvements not described herein are not necessarily excluded from the scope of the invention, the scope of the invention being defined by the following claims.

What is claimed is:

1. A system for determining an internal resistance of a battery, the system comprising:
a processing unit, the processing unit including a storage unit, the storage unit storing at least one predetermined value;
a voltage measuring device, a voltage across the terminals of the battery without a load being measured by the voltage measuring device and applied to the processing unit;
a known load;
a switch coupled in series with the known load between the terminals of the battery, the known load when coupled to the battery providing the internal resistance;
wherein the processing unit determines an internal battery resistance from the voltage value and the known load.

2. The system as recited in claim 1 wherein the switch is controlled by the processing unit.

3. The system as recited in claim 1 wherein the one predetermined value is a resistance value, and wherein the processing unit compares the predetermined value with the internal battery resistance value determined by the processing unit.

4. The system as recited in claim 1 wherein the one predetermined value is a slope value, wherein the processing unit determines a slope from the measured resistance values, and wherein the processing unit determined slope is compared to the predetermined value.

5. The system as recited in claim 1 wherein the processing unit provides notification to the user when the internal resistance value is equal to or greater than the predetermined value.

6. The system as recited in claim 4 wherein the processing unit provides a notification to a user when the slope is greater than or equal to the predetermined value.

7. The method of determining when a battery is failing, the method comprising:
measuring a voltage value of a battery when the battery is not drawing current;
measuring a current value from the battery when the battery is coupled across a known resistance;
from the current value and the voltage value, determining an internal resistance of the battery; and
comparing the internal resistance value with a predetermined value stored in the processing unit.

8. The method as recited in claim 7 further comprising notifying a user when the internal resistance value is greater than the predetermined value.

9. The method of determining when a battery is failing, the method comprising:
measuring a voltage value of a battery when the battery is not drawing current;
measuring a current value from the battery when the battery is coupled across a known resistance;
from the current value and the voltage value, determining an internal resistance of the battery;
storing a time dependent series of internal resistance values;
determining a slope of the function formed by the time dependent series; and
comparing the slope of the function with a predetermined value stored in the processing unit.

10. The method as recited in claim 9 further comprising notifying a user when the slope is greater than or equal to the predetermined value.

11. A method for identifying a failing battery, the method comprising:
measuring the voltages across the terminals of the battery as a function of time;
measuring the current drawn from battery as a function of time;
using the voltages and currents to determine a change in the internal battery resistance as a function of time.
